(19) United States
(12) Patent Application Publication
(10) Pub. No.: US 2016/0375823 A1
(43) Pub. Date: Dec. 29, 2016

(54) VEHICLE INTERIOR ILLUMINATION SYSTEM

(71) Applicant: GM GLOBAL TECHNOLOGY OPERATIONS LLC, Detroit, MI (US)

(72) Inventors: Daniel P. Carlesimo, Rochester, MI (US); Marcelo V Lazarini, Clinton Township, MI (US)

(73) Assignee: GM GLOBAL TECHNOLOGY OPERATIONS LLC, Detroit, MI (US)

(21) Appl. No.: 14/750,245

(22) Filed: Jun. 25, 2015

(51) Int. Cl. B60Q 3/02

(52) U.S. Cl. CPC B60Q 3/0293

(57) ABSTRACT

A method and a device for illuminating an interior space is described and includes a controller including a microcontroller connected to a power control circuit and a signal reading circuit, wherein the power control circuit electrically connects to the signal reading circuit at a node. A lighting device including a light bulb and a user switch connects to the node of the controller via a single electric cable. The microcontroller controls the signal reading circuit to monitor a signal input from the user switch, and includes a control routine executable to control electric power to the lighting device in response to a user request, a user command, and a system request.

### TECHNICAL FIELD

The disclosure relates to vehicle illumination systems, including methods and devices for illuminating a vehicle interior.

### BACKGROUND

Vehicles are equipped with a plurality of interior lighting devices for illuminating the passenger compartment. For example, a vehicle may include a dome lamp for providing light illumination when one or more vehicle doors are open to provide ambient lighting for occupants of the vehicle to enter and exit the vehicle. Additionally, vehicles may be equipped with reading or map lamps that provide ambient lighting to enable passengers to read, view maps, and otherwise aid in vision. Some vehicles employ a reading or map light to serve as the dome light for illuminating a passenger compartment. On some applications, controllable lamps may require use of two electric lead wires in addition to a ground circuit to operate a user switch that is collocated with the lamp.

### SUMMARY

A device for illuminating an interior space is described and includes a controller including a microcontroller connected to a power control circuit and a signal reading circuit, wherein the power control circuit electrically connects to the signal reading circuit at a node. A lighting device including a light bulb and a user switch connects to the node of the controller via a single electric cable. The microcontroller controls the signal reading circuit to monitor a signal input from the user switch, and includes a control routine executable to control electric power to the lighting device in response to a user request, a user command, and a system request.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically illustrates an electric circuit including a controller electrically connected via a single wire cable to a lighting device in accordance with the disclosure; and

FIG. 2 schematically illustrates a control routine in the form of a state diagram that may be executed to monitor inputs and control activation and deactivation of an embodiment of the electric circuit, controller and lighting device described with reference to FIG. 1 by communicating and conveying electric power through the single wire cable, in accordance with the disclosure.

### DETAILED DESCRIPTION

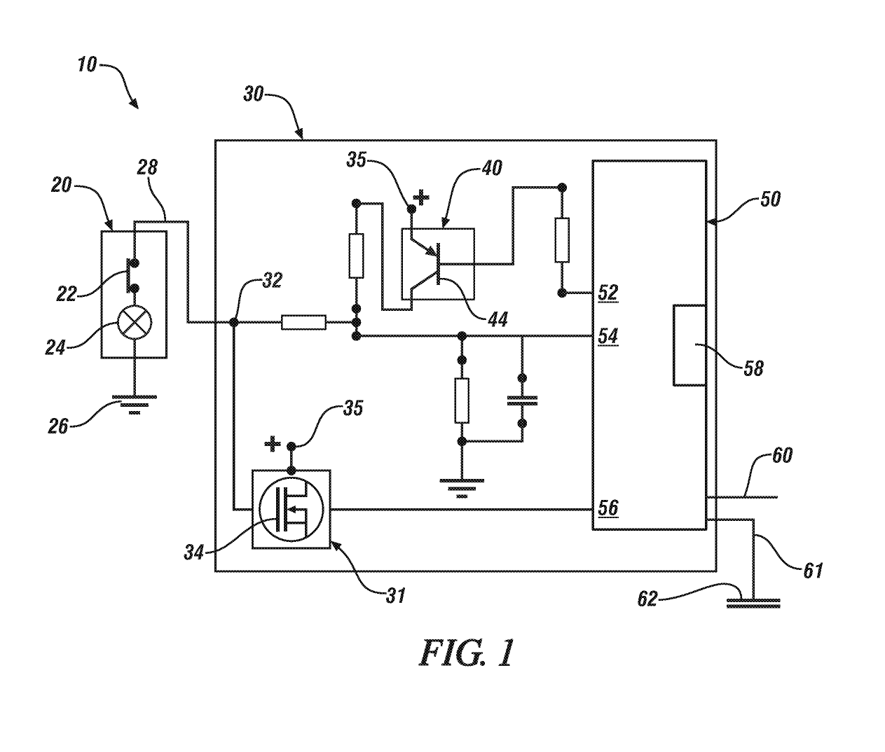

Referring now to the drawings, wherein the depictions are for the purpose of illustrating certain exemplary embodiments only and not for the purpose of limiting the same, FIG. 1 schematically illustrates an electric circuit 10 including a controller 30 electrically connected via a single wire cable 28 to a lighting device 20, which may be remotely located. By way of a non-limiting example, the lighting device 20 may be located in a headliner portion of a vehicle interior and the electric circuit 10 may be located in a center console area of a vehicle interior. The controller 30 includes a microcontroller 50 having a resident control routine 100 that executes to activate and deactivate the lighting device 20. The electric circuit 10 that may be advantageously employed to illuminate a space such as a vehicle interior when deployed on a vehicle. The concepts described herein are not limited to deployment or implementation on a vehicle, and may be advantageously employed in any arrangement wherein a controllable lighting system is desired. By way of non-limiting examples, applications may include a passenger vehicle, a heavy-duty truck, an agricultural vehicle, a construction vehicle, an airplane cockpit, and an office arrangement such as a cubicle, among others. Like numerals indicate like or corresponding parts throughout the several views.

The lighting device 20 is preferably connected in series between the single wire electric cable 28 and an electrical ground 26. The lighting device 20 includes a light bulb 24 that is connected in series with a user switch 22. The light bulb 24 may be any suitable electrically illuminated device, e.g., an incandescent bulb, a light-emitting diode (LED), or another suitable device. The lighting device 20 also includes electric circuits such as buffers, filters and other electrical circuit elements to support operation of the light bulb 24.

The user switch 22 is preferably a normally-closed momentary switching device that may be activated by a user, such as a passenger or a vehicle operator. Activation of the user switch 22 by a user results in a momentary open circuit between the light bulb 24 and the controller 30 during the period of time when the user is pressing or otherwise activating the user switch 22, wherein the circuit between the light bulb 24 and the controller 30 closes when the user discontinues activating the user switch 22. The user switch 22 may be any biased operator-activated push-to-break momentary switch device, such as a mechanical switch, a capacitive touch switch, a piezoelectric device, a piezoresistive device, a thermal device, or any other suitable device.

The controller 30 includes the microcontroller 50, a power control circuit 31 and a signal reading circuit 40. The power control circuit 31 and the signal reading circuit 40 have a common junction point at node 32, which electrically connects to the single wire electric cable 28 of the lighting device 20.

The microcontroller 50 is an integrated electronic circuit that includes a processor core, one or multiple memory devices 58, and input/output nodes 52, 54, and 56 for communications with and control of peripheral devices including the power control circuit 31 and the signal reading circuit 40. The microcontroller 50 may any one of a plurality of commercially available microcontroller devices that may be configured as described herein. The microcontroller 50 preferably includes other input/output nodes for communications with other controllers and external devices, including ports 60 and 61 as shown. The microcontroller 50 includes executable code related to the control routine 100 to activate and deactivate the lighting device 20 in response to a user request, a user command, and a system request. As used herein, a ‘user command’ is an event wherein a user activates the lighting device 20 or deactivates the lighting device 20 by activating the user switch 22. As used herein, a ‘user request’ is any user-initiated event wherein a user engages in an activity in which they may expect automatic activation of the lighting device 20 coincident with the activity, but the user does not command activation of the light device 20 via the user switch 22. When the lighting device 20 is deployed on a vehicle, a user request may include, by way of illustrative examples, a user opening a passenger door, a user sending an activation command from a remote keyless entry device, a user executing vehicle key-off, or any other user-requested action. As used herein, a ‘system request’ is any event wherein another system on the vehicle requests activation of the lighting device 20 that is not in response to a user request or a user command.

The signal-read circuit 40 includes a controllable switch 44, e.g., a bipolar junction transistor, and other electronic and electrical circuit elements for electrical signal filtering and buffering. The signal-read circuit 40 may be activated and deactivated by a read-enable output signal communicated from the output node 52. The output node 52 communicates the read-enable output signal, i.e., 1 or 0, to the signal-read circuit 40 of the microcontroller 50. By way of a non-limiting example, when the discrete output signal from the output node 52 is 1, the input signal from the single wire electric cable 28 of the lighting device 20 that is communicated through node 32 may be read by the microcontroller 50 at input node 54. The input node 54 preferably connects to an analog-to-digital converter that is resident in the microcontroller 50.

The power control circuit 31 may include a controllable switch 34, e.g., a field-effect transistor, and other electronic and electrical circuit elements for electrical signal filtering and buffering. In one embodiment, the switch 34 includes current monitoring circuitry. By way of a non-limiting example, the controllable switch 34 may be activated and deactivated by a discrete output signal, i.e., 1 and 0, respectively, that is communicated from the output node 56 of the microcontroller 50. When the discrete output signal from the output node 56 is 1, electric power originating from a DC power supply 35 is supplied through junction node 32 to the single wire electric cable 28 of the lighting device 20 to power and thus illuminate the light bulb 24.

In one embodiment, the microcontroller 50 periodically commands the discrete output signal at output node 52 to 1, activating the signal-read circuit 40 and enabling the microcontroller 50 to read the input signal at input node 54 that is communicated from the user switch 22 of the lighting device 20 via the single wire electric cable 28 through node 32. The microcontroller 50 executes the control routine 100 to command operation of the power control circuit 31 to control the controllable switch 34 to supply electric power to the lighting device 20 via the single wire electric cable 28. The microcontroller 50 also monitors electric load of the power control circuit 31 and detects occurrence of a fault in the user switch 22, the lighting device 20 and the single wire electric cable 28, with such faults including either a short to ground fault, an open fault, or a stuck switch fault. Upon detecting such a fault, the microcontroller 50 ramps off power to the power control circuit 31 and communicates occurrence of such fault to another on-vehicle controller.

Port 61 may include any suitably configured input node that receives signals associated with one or a plurality of user requests. Port 61 may be configured to receive one or a plurality of signals associated with one or a plurality of user requests in the form of discrete input signals, analog input signals, or messages from a high-speed communications bus 62.

Port 60 may include any suitably configured input node that receives one or a plurality of system requests. One system request includes, by way of an illustrative example, a request for activation of the lighting device 20 that is related to occurrence of a vehicle event that causes deployment of a supplemental inflatable restraint (SIR) device. In one embodiment, port 60 may be configured as a high-speed communications port that connects to the communications bus 62 for communication between the microcontroller 50 and other on-vehicle controllers.

The terms microcontroller, controller, control module, module, control, control unit, processor and similar terms refer to any one or various combinations of Application Specific Integrated Circuit(s) (ASIC), electronic circuit(s), central processing unit(s), e.g., microprocessor(s) and associated non-transitory memory component 58 in the form of memory and storage devices (read only, programmable read only, random access, hard drive, etc.). The non-transitory memory component 58 is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean any controller-executable instruction sets including calibrations and look-up tables. Each controller executes control routine(s) to provide desired functions, including monitoring inputs from sensing devices and other networked controllers and executing control and diagnostic routines to control operation of actuators. Routines may be executed at periodic intervals during ongoing operation. Alternatively, routines may be executed in response to occurrence of a triggering event. Communications between controllers and between controllers, actuators and/or sensors may be accomplished using a direct wired link, a networked communications bus link, a wireless link or any another suitable communications link. Communications includes exchanging data signals in any suitable form, including, for example, electrical signals via a conductive medium, electromagnetic signals via air, optical signals via optical waveguides, and the like. Data signals may include signals representing inputs from sensors, signals representing actuator commands, and communications signals between controllers.

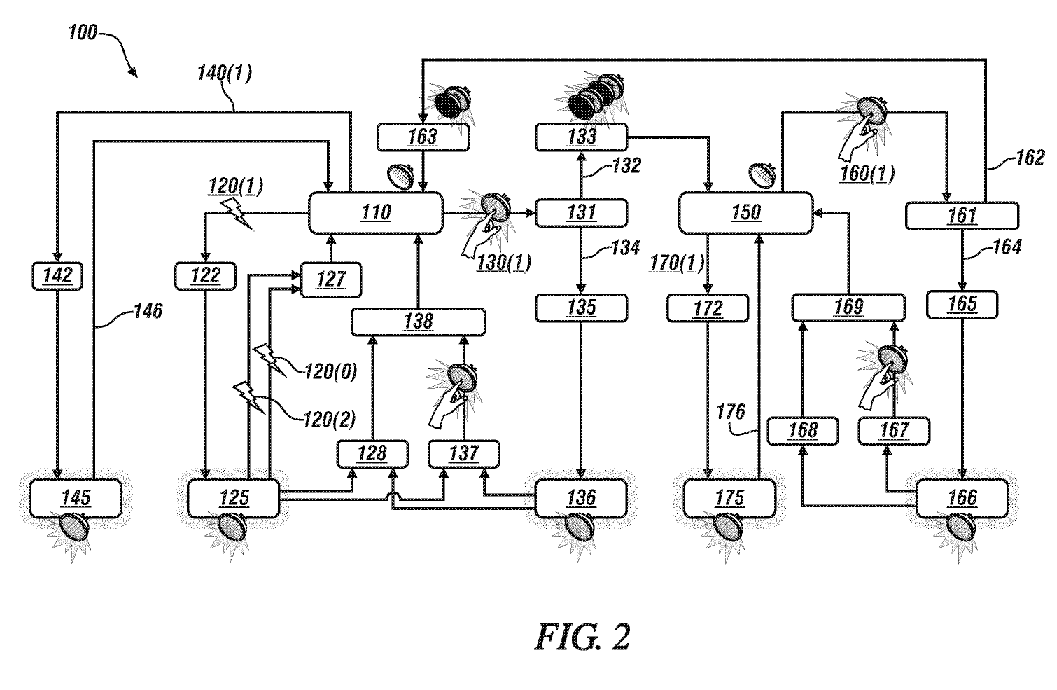

FIG. 2 schematically shows a control routine 100 in the form of a state diagram, wherein the control routine 100 preferably resides in the memory device 58 of the microcontroller 50 as executable code and calibration values. The control routine 100 may be executed by the microcontroller 50 to monitor various inputs and control activation and deactivation of the lighting device 20 described with reference to FIG. 1 by communicating and conveying electric power through the single wire cable 28. As used herein, the state diagram 100 is a model of a reactive system that defines a finite set of states, e.g., a lamp ON state caused by controlling or otherwise enabling flow of electric power to activate the lighting device 20 and a lamp OFF state caused by controlling or otherwise disabling flow of electric power to deactivate the lighting device 20, and related transitions from one state to another state in response to various inputs. The inputs include, by way of example, the user request, the user command, and the system request, which may be either active, i.e., TRUE (1) or inactive, i.e., FALSE (0).

The control routine 100 includes an initial state 110 for the lighting device 20, which includes the lamp 24 in the OFF state and a user request function enabled, thus enabling the microcontroller 50 to activate the lighting device 20 to illuminate the lamp 24 in response to a user request such as opening of a vehicle door. Each of the user request 120, the user command 130, and the system request 140 are not activated, i.e., all are FALSE.

The user command 130 is enabled when the user activates the user switch 22 by pressing or otherwise activating the user switch 22 to activate the lighting device 20 to illuminate the lamp 24. When the user command 130 is activated by the user to provide the activated user command 130(1), the microcontroller 50 monitors the length of time the user switch 22 is activated (131). When the user switch 22 is activated for an extended period of time, e.g., 3 to 5 seconds (132), the microcontroller 50 blinks the lamp 24 as visual feedback to acknowledge the user input, and disables the user request functions, thus disabling illuminating the lamp 24 in response to a user request such as opening of a vehicle door (133). A second state 150 is activated, with the user request function disabled, the lamp 24 in the OFF state, and the user request 120, the user command 130, and the system request 140 inactivate, i.e., all are FALSE. When the user switch 22 is activated for a short period of time, e.g., less than 100 ms (134), the microcontroller 50 ramps in electric power (135) to the lighting device 20 to illuminate the lamp 24 (136). The lamp 24 may remain in the ON state, i.e., illuminated indefinitely, or may be deactivated in response to an event. The user may execute an override of the activated user command 130(1) and command the lamp 24 to the OFF state by activating the user switch 22 (137), wherein the user activates the user switch 22 for either a short activation time or a long activation time to command deactivation of the lamp 24 (138) and return the lighting device 20 to the initial state 110. The microcontroller 50 may override the activated user command 130(1) when the lamp 24 has inadvertently been left in the ON state for a period of time that is greater than a threshold period of time, e.g., greater than ten minutes (128). In this case, the microcontroller 50 commands deactivation of the lamp 24 (138) and returns the lighting device 20 to the initial state 110.

The user request 120 may be activated by any related user-initiated event, such as a user opening a passenger door, a user sending an activation command from a remote keyless entry device, or a user executing a vehicle key-off. When the user request is activated 120(1), the microcontroller 50 ramps in electric power (122) to the lighting device 20 to illuminate the lamp 24 (125). The lamp 24 may remain illuminated indefinitely, or may be deactivated in response to an event. The activated user request 120(1) may be subsequently deactivated by another action of the user (120(0)), causing the microcontroller 50 to ramp out electric power (127) to the lighting device 20 over a period of time, e.g., 1 to 2 seconds, to deactivate the lamp 24 and return the lighting device 20 to the initial state 110. Such user action (120(0)) may include closing of a vehicle door. The user may execute an override to command the lamp 24 to the OFF state by activating the user switch 22 (137), wherein the user activates the user switch 22 for either a short activation time or a long activation time to command deactivation of the lamp 24 (138) and return the lighting device 20 to the initial state 110. The microcontroller 50 may exercise an override to command the lamp 24 to the OFF state when the lamp 24 has inadvertently been left in the ON state for a period of time that is greater than a threshold period of time, e.g., greater than ten minutes (128). In this case, the microcontroller 50 commands deactivation of the lamp 24 (138) and returns the lighting device 20 to the initial state 110.

The activated user request 120(1) may be subsequently deactivated by action of the microcontroller 50 in response to the microcontroller 50 detecting a fault in the electric circuit 10 including the controller 30, the single wire cable 28 or the lighting device 20, wherein the fault may be either a short-to-ground fault, an open circuit fault, or a fault in either the power control circuit 31 or the signal reading circuit 40. As shown herein, when the lamp is illuminated (125) and a fault is detected by the microcontroller 50 (120(2)), the microcontroller 50 ramps out electric power (127) to the lighting device 20 to deactivate the lamp 24 and return the lighting device 20 to the initial state 110. The fault detection step (120(2)) is illustrative. Fault monitoring by the microcontroller 50 occurs independently of execution of the control routine 100. Thus, the microcontroller 50 ramps out electric power to the lighting device 20 to deactivate the lamp 24 upon detection of a fault in the electric circuit 10 regardless of the present step of the control routine 100.

The system request 140 may be activated by a signal originating from another system on the vehicle requesting activation of the lighting device 20 that is not in response to a user request or a user command. When the system request is activated 140(1), the microcontroller 50 ramps in electric power (142) to the lighting device 20 to illuminate the lamp 24 (145). The lamp 24 remains illuminated for a preset period of time, e.g., fifteen seconds, after which the microcontroller 50 commands deactivation of the lamp 24 (146) and returns the lighting device 20 to the initial state 110.

When the second state 150 is activated, the user request function is disabled, the lamp 24 is in the OFF state, and the user request 120, the user command 130, and the system request 140 are inactive, i.e., all are FALSE. The microcontroller 50 responds to user commands 160 and system requests 170 in the second state 150, but does not respond to user requests in the second state 150.

The system request 170 may be activated by a signal originating from another system on the vehicle requesting activation of the lighting device 20 that is not in response to a user request or a user command. When the system request is activated 170(1), the microcontroller 50 ramps in electric power (172) to the lighting device 20 to illuminate the lamp 24 (175). The lamp 24 remains illuminated for a preset period of time, e.g., fifteen seconds, after which the microcontroller 50 commands deactivation of the lamp 24 (176) and returns the lighting device 20 to the second state 150.

The user command 160 may be activated by the user activating the user switch 22, i.e., pressing the user switch 22 to activate the lighting device 20 to illuminate the lamp 24. When the user command 160 is activated by the user to provide an activated user command 160(1), the microcontroller 50 monitors the length of time the user switch 22 is activated (161). When the user switch 22 is activated for an extended period of time, e.g., greater than 3 to 5 seconds (162), the microcontroller 50 blinks the lamp 24 as visual feedback to acknowledge the user input, and enables the user request functions, thus enabling illuminating the lamp 24 in response to a user request such as opening of a vehicle door (163). The initial state 110 is re-activated, with the user request function enabled, the lamp 24 in the OFF state, and the user request 120, the user command 130, and the system request 140 deactivated, i.e., all are FALSE. Otherwise, when the user switch 22 is activated for a short period of time, e.g., less than 100 ms (164), the microcontroller 50 ramps in electric power (165) to the lighting device 20 to illuminate the lamp 24 (166). The lamp 24 may remain illuminated indefinitely, or may be deactivated in response to an event. The user may execute an override and command the lamp 24 to the OFF state by activating the user switch 22 (167), wherein the user activates the user switch 22 for either a short activation time or a long activation time to command deactivation of the lamp 24 (169) and return the lighting device 20 to the second state 150. The microcontroller 50 may execute an override to command the lamp 24 to the OFF state when the lamp 24 has inadvertently been left in the ON state for a period of time that is greater than a threshold period of time, e.g., greater than ten minutes (168). In this case, the microcontroller 50 commands deactivation of the lamp 24 (169) and returns the lighting device 20 to the second state 150.

Embodiments of the electric circuit 10 including the controller 30 that electrically connects via the single wire cable 28 to the lighting device 20 and associated control routine 100 provide an easy-to-use lighting system that provides multiple lighting functions and reduces mass by reducing wire count compared to known lighting systems that provide the same functions.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A device for illuminating an interior space, comprising:
a controller including a microcontroller connected to a power control circuit and a signal reading circuit, wherein the power control circuit electrically connects to the signal reading circuit at a node;
a lighting device including light bulb and a user switch connected to the node of the controller via a single electric cable, wherein the user switch comprises a normally-closed momentary switching device;
the microcontroller controlling the signal reading circuit to monitor a signal input from the user switch; and
the microcontroller including a control routine executable to control electric power to the lighting device in response to a user request, a user command, and a system request.

2. The device of claim 1, wherein the lighting device is remotely located from the controller.

3. (canceled)

4. The device of claim 1, wherein the control routine executable to control electric power to the lighting device in response to the user request comprises the control routine executable to control electric power to activate the lighting device in response to an event that includes an automatic activation of the lighting device.

5. The device of claim 4, wherein an event that includes automatic activation of the lighting device comprises one of opening of a passenger door, commanding activation from a remote keyless entry device, and executing a vehicle key-off when the interior space is a vehicle interior.

6. The device of claim 5, further comprising the control routine executable to control electric power to deactivate the lighting device in response to activation of the user switch when the lighting device is activated.

7. The device of claim 4, further comprising the control routine executable to control electric power to deactivate the lighting device in response to an activation of the user switch for an extended period of time.

8. The device of claim 1, wherein the control routine executable to control electric power to activate the lighting device in response to the user command comprises the control routine executable to control electric power to activate the lighting device in response to an activation of the user switch.

9. The device of claim 8, further comprising the control routine executable to control electric power to deactivate the lighting device in response to an activation of the user switch that occurs when the lighting device is activated.

10. The device of claim 1, wherein the control routine executable to control electric power to the lighting device in response to the system request comprises the control routine executable to control electric power to activate the lighting device in response to a system request for activation of the lighting device that is not in response to a user request or a user command.

11. The device of claim 10, wherein the control routine controls electric power to activate the lighting device in response to a system request comprising a request for activation of the lighting device related to occurrence of an event that causes deployment of a supplemental inflatable restraint device.

12. The device of claim 11, further comprising the control routine executable to control electric power to deactivate the lighting device after a preset period of time elapses.

13. The device of claim 1, further comprising the control routine executable to control electric power to deactivate the lighting device when the lighting device has been inadvertently activated for a period of time that is greater than a threshold period of time.

14. A method for illuminating an interior space employing a lighting device including a light bulb and a normally-closed momentary user switch connected to a node of a controller via a single electric cable, the controller including a microcontroller connected to a power control circuit and a signal reading circuit, wherein the power control circuit electrically connects to the signal reading circuit at the node, the method comprising:
monitoring signal input from the normally-closed momentary user switch; and
activating the lighting device in response to a user request, a user command, and a system request, including controlling electric power to the lighting device responsive to the signal input from the user switch.

15. The method of claim 14, wherein activating the lighting device in response to the user request comprises activating the lighting device in response to an event that includes automatic activation of the lighting device.

16. The method of claim 15, wherein an event that includes automatic activation of the lighting device comprises one of opening of a passenger door, commanding activation from a remote keyless entry device, and executing a vehicle key-off when the interior space is a vehicle interior.

17. The method of claim 16, further comprising deactivating the lighting device in response to activation of the user switch when the lighting device is in the ON state.

18. The method of claim 14, wherein activating the lighting device in response to the user command comprises activating the lighting device in response to a user activation of the normally-closed momentary user switch.

19. The method of claim 18, further comprising deactivating the lighting device in response to the user activation of the normally-closed momentary user switch when the lighting device is in the ON state.

20. The method of claim 14, wherein activating the lighting device comprises ramping in the electric power to the lighting device.

21. The device of claim 1, wherein the lighting device includes the light bulb and the user switch connected in series, and wherein the lighting device is connected between the single electric cable and an electrical ground, including the user switch connected to the node of the controller via the single electric cable, and the light bulb connected to the electrical ground.
